(19) United States
(12) Patent Application Publication
(10) Pub. No.: US 2006/0136522 A1
(43) Pub. Date: Jun. 22, 2006

(54) Computer system, storage management program call-up method, and storage system

(76) Inventors: Yukinori Sakashita, Sagamihara (JP); Atsushi Murase, Sagamihara (JP); Masahide Sato, Noda (JP); Manabu Obana, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/102,858

(22) Filed: Apr. 11, 2005

(30) Foreign Application Priority Data
Dec. 20, 2004 (JP) 2004-367656

(51) Int. Cl. G06F 12/00; G06F 17/30

(52) U.S. Cl. 707/204

(57) ABSTRACT

This invention enables a storage management program to easily obtain an attribute of another storage management programs managing the storage system. A computer system including a first management server, a second management server, and a storage system, in which the first management server comprises a control unit to execute a first storage management program, which manages the storage system, the second management server comprises a control unit to execute a second storage management program, which manages the storage system in a manner different from the first storage management program, the storage system comprises a storing unit to store an attribute of the first storage management program which manages the storage system and an attribute of the second storage management program which manages the storage system, and the first storage management program obtains the attribute of the second storage management program from the storage system to manage the storage system.

### CLAIM OF PRIORITY

The present application claims priority from Japanese patent application P2004-367656 filed on Dec. 20, 2004, the content of which is hereby incorporated by reference into this application.

### BACKGROUND

This invention relates to a storage system management method, and more specifically to a technique of obtaining attributes of a storage management program.

Recent computer systems have many storage systems. A storage system itself has, in addition to disks as its main components, various I/Fs, a number of memories, and a controller capable of high-speed processing. Thus, there arises a need to manage different aspects of a storage system by plural storage management programs distributed over plural computers on a network, as discussed in JP 2003-316607 A.

When plural storage management programs manage a storage system in cooperation with one another, one of the storage management programs is to communicate with another. Thus, the storage management program that initiates communication needs information indicating the location of another storage management program as its communication target and cooperation partner.

Conventionally, to achieve cooperation between storage management programs, a storage management program that initiates cooperation holds location information (for example, IP address) of its cooperation partner storage management program.

JP 11-316693 A discloses, as a method of making plural storage management programs work in cooperation with one another, a technique in which a computer loaded with a data cooperation control program manages location information or the like of cooperating programs. Upon receiving a data transmission request from a computer loaded with one of the cooperating programs that initiates cooperation, the computer loaded with a data cooperation control program identifies a computer loaded with its cooperation partner program, so that data is sent from the computer having the cooperation initiating program to the computer having the cooperation partner program.

In the prior art described above, installing a new storage management program has to follow advance notification of the IP address or the like of a computer in which the new program is to be installed for establishing a cooperative operation with the existing storage management programs. The advance notification is also necessary when one of the storage management programs is upgraded to a newer version and when there is a change in location of the computers on the network.

With the technique disclosed in JP 11-316693 A, changes in cooperating storage management programs such as installation, a version upgrade, and relocation necessitate setting the storage system anew. In such a case, the computer that executes the cooperation control program (an integrating server) also has to be notified of the new location of the relocated program.

This increases a maintenance burden particularly when a program is newly installed in a management server to cooperate with programs loaded in plural management servers, or when a program which has been executed by one management server is switched to another management server, since every management server loaded with a cooperation initiating program has to be notified of the new location of its cooperation partner program so that the cooperation partner program location settings that have been set in the cooperation initiating program can be changed to the new location settings.

A change in location of a cooperation partner program necessitates not only changing settings of the storage system managed by this program but also registering the location change of the cooperation partner program in a computer that executes a cooperation initiating program or in the integrating server which executes the cooperation control program.

### SUMMARY

It is therefore an object of this invention to facilitate cooperation between the plural programs that manage a storage system while lessening a burden of maintaining the plural storage management programs.

According to the embodiment of this invention, there is provided a computer system including a first management server, a second management server, and a storage system, in which the first management server comprises a control unit to execute a first storage management program which manages the storage system, the second management server comprises a control unit to execute a second storage management program which manages the storage system in a manner different from the first storage management program, the storage system comprises a storing unit to store an attribute of the first storage management program which manages the storage system and an attribute of the second storage management program which manages the storage system, and the first storage management program obtains the attribute of the second storage management program from the storage system to manage the storage system.

The embodiment of this invention enables one of the storage management programs to obtain the attribute of another storage management program managing the storage system.

### BRIEF DESCRIPTION OF THE DRAWINGS

The present invention can be appreciated by the description which follows in conjunction with the following figures, wherein:

FIG. 1 is a configuration diagram of a computer system according to a first embodiment of this invention;

FIG. 2 is a configuration diagram of the storage management program attribute according to the first embodiment;

FIG. 3 is a flow chart of registration processing 1 (performed by a management server) to register the storage management program attribute according to the first embodiment;

FIG. 4 is a flow chart of registration processing 2 (performed by a storage system) to register the storage management program attribute according to the first embodiment;

FIG. 5 is a flow chart of updating processing 1 (performed by the management server) to update the storage management program attribute according to the first embodiment;

FIG. 6 is a flow chart of updating processing 2 (performed by the storage system) to update the storage management program attribute according to the first embodiment;

FIG. 7 is a flow chart of deletion processing 1 (performed by the management server) to delete the storage management program attribute 301 according to the first embodiment;

FIG. 8 is a flow chart of deletion processing 2 (performed by the storage system) to delete the storage management program attribute according to the first embodiment;

FIG. 9 is an explanatory diagram of how storage management programs cooperate with one another in the first embodiment;

FIG. 10 is a flow chart of a cooperation organizing processing of the storage management program (performed by the management server A) in the first embodiment;

FIG. 11 is a flow chart of the processing (performed in the storage system) while the storage management programs are cooperating with one another according to the first embodiment;

FIG. 12 is a flow chart for processing of notifying a storage management program of a failure according to the first embodiment;

FIG. 13 is an explanatory diagram of a storage management program call-up screen according to the first embodiment;

FIG. 14 is an explanatory diagram of how storage management programs cooperate with one another in a second embodiment;

FIG. 15 is a flow chart of processing performed by the storage system 3 in the second embodiment;

FIG. 16 is an explanatory diagram of how storage management programs cooperate with one another in a third embodiment; and

FIG. 17 is a flow chart of processing performed by the storage system 3 in the third embodiment.

### DETAILED DESCRIPTION OF THE PREFERRED EMBODIMENTS

Embodiments of this invention will be described below.

### First Embodiment

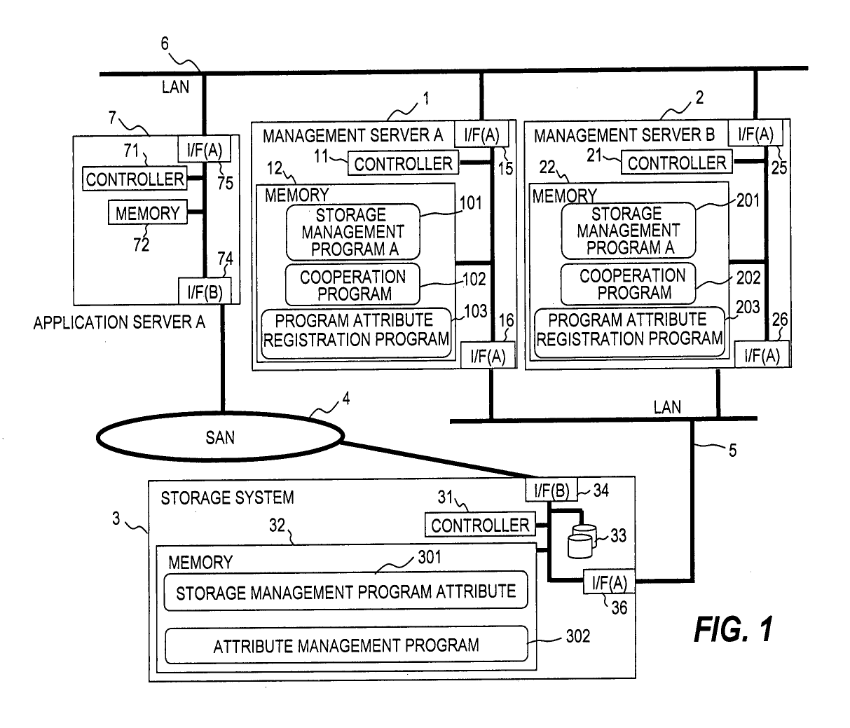

FIG. 1 is a configuration diagram of a computer system according to a first embodiment of this invention.

The computer system according to the first embodiment is composed of a management server A 1, a management server B 2, a storage system 3, an application server A 7, and networks 4, 5 and 6, which connect the servers and the storage system to one another.

The management server A 1 is a computer device equipped with a controller (CPU) 11, a memory 12, and network interfaces 15 and 16. Though omitted from the drawing, input/output devices (a keyboard, a display device, and the like) may be provided in the management server A 1.

The memory 12 stores a storage management program A 101, a cooperation program 102, and a program attribute registration program 103. The cooperation program 102 is a program that controls cooperation between the storage management program A 101 and another storage management program. The program attribute registration program 103 is a program that controls the storage system 3 when the storage management program A 101 is installed in the management server 1 or when the storage management program A 101 is updated. The controller 11 reads various programs stored in the memory 12 to execute the read programs. Those programs may be stored in an external storage medium instead. The cooperation program 102 and the program attribute registration program 103 may be composed of the hardware configuration of the management server A 1 is designed to have functions equal to those of the programs 102 and 103.

The network interface (A) 15 is connected to the LAN 6, thereby enabling the management server A 1 to exchange, via the LAN 6, data and control signals with the application server A 7.

The network interface (A) 16 is connected to the LAN 5, thereby enabling the management server A 1 to exchange, via the LAN 5, data and control signals with the storage system 3 and the management server B 2.

The management server B 2 is a computer device equipped with a controller (CPU) 21, a memory 22, and network interfaces 25 and 26. Though omitted from the drawing, input/output devices (a keyboard, a display device, and the like) may be provided in the management server B 2.

The memory 22 stores a storage management program B 201, a cooperation program 202, and a program attribute registration program 203. The cooperation program 202 is a program that controls cooperation between the storage management program B 201 and another storage management program. The program attribute registration program 203 is a program that controls the storage system 3 when the storage management program B 201 is installed in the management server B 2 or when the storage management program B 201 is updated. The controller 21 reads various programs stored in the memory 22 to execute the read programs. Those programs may be stored in an external storage medium instead. The cooperation program 202 and the program attribute registration program 203 may be composed of the hardware configuration of the management server B 2 is designed to have functions equal to those of the programs 202 and 203.

The network interface (A) 25 is connected to the LAN 6, thereby enabling the management server B 2 to exchange, via the LAN 6, data and control signals with the application server A 7.

The network interface (A) 26 is connected to the LAN 5, thereby enabling the management server B 2 to exchange, via the LAN 5, data and control signals with the storage system 3 and the management server A 1.

The storage system 3 is a storage system composed of a controller (disk array controller) 31, a memory 32, plural disk drives 33, and network interfaces 34 and 35.

The disk array controller 31 is provided with a CPU, a cache memory, and an interface. The CPU executes a control program to control data inputted to and outputted from disks upon request from the management server A 1. The CPU also manages a RAID (Redundant Array of Independent Disks) constituted of the disks.

The memory 32 stores storage management program attribute 301 and a attribute management program 302. The storage management program attribute 301 are used by the storage management programs of the management server A 1 and the management server B 2. The attribute management program 302 registers, updates and deletes the storage management program attribute 301.

The network interface (B) 34 is connected to the SAN 4, thereby enabling the storage system 3 to exchange, via the SAN 4, data and control signals with the application server A 7.

The network interface (A) 36 is connected to the LAN 5, thereby enabling the storage system 3 to exchange, via the LAN 5, data and control signals with the management server A 1 and the management server B 2.

The application server A 7 executes an application that requests data be written or read in a storage area of the storage system, a backup application, and other applications. The operation server A 7 is provided with a controller (CPU) 71, a memory 72, and network interfaces 74 and 75.

The memory 72 stores application programs that use data stored in the storage system 3. The controller 71 executes the application programs to perform various processing.

The network interface (A) 75, is connected to the LAN 6, thereby enabling the application server A 7 to exchange, via the LAN 6, data and control signals with the management server A 1 and the management server B 2.

The network interface (B) 76 is connected to the SAN 4, thereby enabling the application server A 7 to exchange, via the SAN 4, data and control signals with the storage system 3.

The SAN (Storage Area Network) 4 is a network connecting the application server A 7 and the storage system 3 to one another, and employs, for example, a fiber channel protocol to transfer data and control signals.

The LAN (Local Area Network) 5 is a network connecting the management server A 1, the management server B 2 and, the storage system 3 to one another, and employs, for example, a TCP/IP protocol to transfer data and control signals.

The LAN (Local Area Network) 6 is a network connecting the application server A 7, the management server A 1, and the management server B 2 to one another, and employs, for example, a TCP/IP protocol to transfer data and control signals.

This embodiment uses plural networks to connect the management servers 1 and 2 and the storage system 3 to one another, but may employ a single network instead. In other words, control signals (e.g., a request for an attribute of a storage management program and a response to the request) may be exchanged between the management servers A 1 and B 2 and the storage system 3 over the same network that is used to input and output data to and from the storage system 3 (in-band).

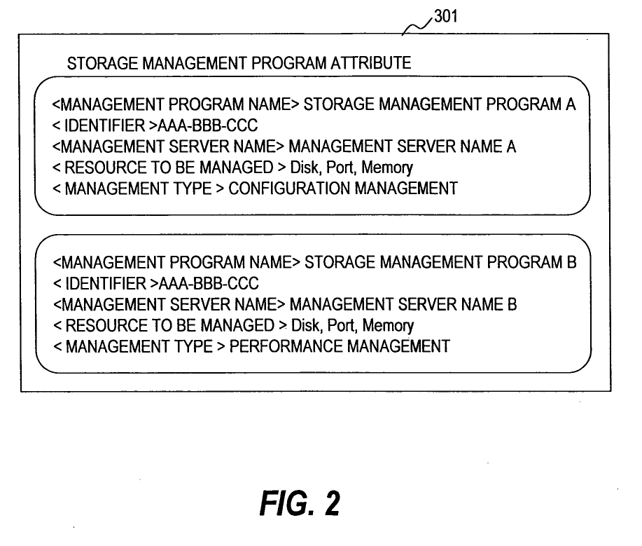

FIG. 2 is a configuration diagram of the storage management program attribute 301 according to the first embodiment.

The storage management program attribute 301 is the attribute of the storage management programs that manage the storage system 3. The attribute is recorded as the storage management program attribute 301 when the storage system is set as a resource to be managed to the storage management programs of the management servers.

Stored as the storage management program attribute 301 for each storage management program is the name of the storage management program, the identifier of the storage management program, a management server name, a resource to be managed, and a management type.

A storage management program identifier is an identifier unique to each storage management program, and a serial number assigned to each storage management programs can serve as the storage management program identifier. Alternatively, an identifier set for each storage management program type defined by the purpose of the program (for example, a log output) may be employed.

The location of a management server that executes the storage management program identified by the identifier is stored as a management server name. The location of the management server is expressed by, for example, IP address.

A resource to be managed is a subject that is managed by this storage management program. Examples of the resource to be managed include a disk drive, an I/O port of an interface, and a cache memory.

Stored as a management type is the type of management executed by this storage management program. There are several management types, including configuration management in which the configuration of the storage system is set or changed, and performance management in which the performance of the storage system is optimized or otherwise managed. A resource to be managed and a management type are stored as text information in this embodiment. Alternatively, a resource to be managed and a management type may be stored in the form of flags that are set for each resource to be managed and management type.

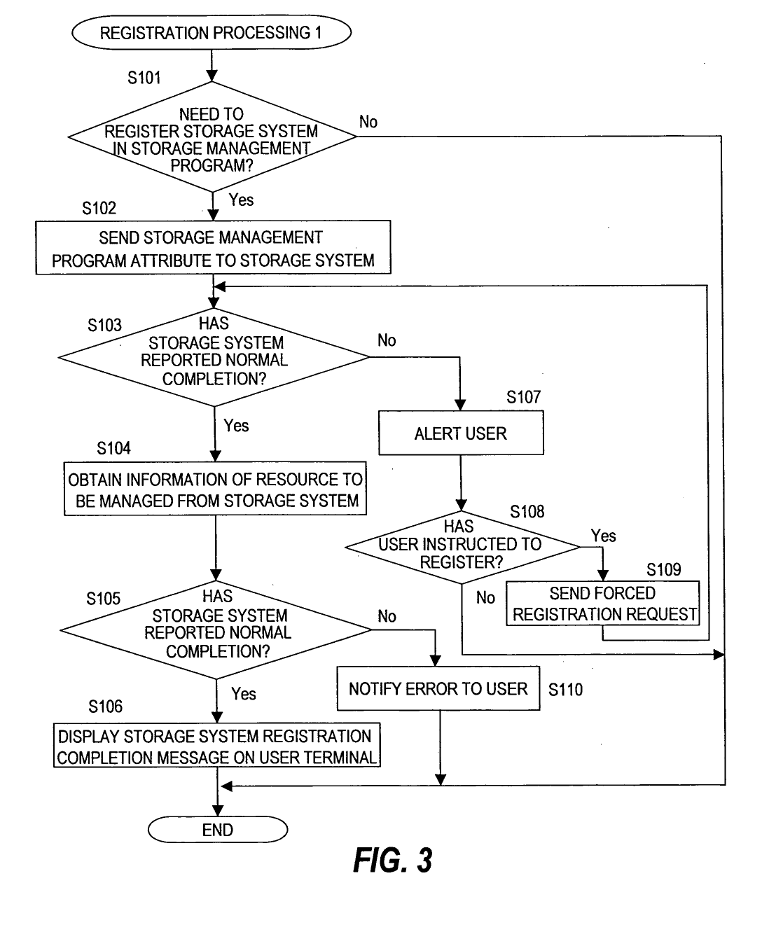

FIG. 3 is a flow chart of Registration Processing One to register the storage management program attribute 301 according to the first embodiment. This processing is executed by the attribute management program 103.

Processing described in the following description is executed by the program attribute registration program 103, which is executed on the management server A 1. The program attribute registration program 203, which is executed on the management server B 2, performs similar processing.

First, the program attribute registration program 103 judges whether or not to register the storage system 3 in the storage management program A 101, or other storage management programs (S101). This can be judged by, for instance, an instruction from a user. It may be automatically judged that registration is necessary when a new storage management program is installed.

When there is no need to register the storage system 3 in the storage management program A 101 or other storage management programs, this program is terminated. On the other hand, when the storage system 3 needs to be registered in the storage management program A 101 or other storage management programs, attribute of this storage management program is sent to the storage system 3 (S102).

The program attribute registration program 103 then waits for a response from the storage system 3. Once a response is received from the storage system 3, the program attribute registration program 103 judges whether or not the response is to report normal completion (S103).

At this point, the storage system 3 may use given authentication information (for example, a user ID and a password) to authenticate a management server that has sent storage management program attribute to the storage system 3 to be registered. This authentication step ensures security for access to the storage system 3.

When the storage system 3 does not report normal completion, the program attribute registration program 103 alerts the user since there is a fear that the storage management program attribute is not registered normally (S107). For instance, a warning message is outputted to a display, or e-mail or the like is sent to a computer that is available to the user.

Then the program attribute registration program 103 judges whether or not there is a further instruction from the user that insists on registration (S108). When there is a registration instruction sent by the user through the input device, a forced registration request is sent to the storage system 3 (S109). When the user sends no further registration instruction, on the other hand, this program ends without registering the storage system 3 in the storage management program A 101 or other programs.

In the case where the storage system 3 reports normal completion, the program attribute registration program 103 obtains, from the storage system 3, information on the resource to be managed such as a disk drive capacity (S104).

The program attribute registration program 103 then waits for a response from the storage system 3. Once a response is received from the storage system 3, the program attribute registration program 103 judges whether or not the response is to report normal completion (S105).

When the storage system 3 does not report normal completion, it means that the storage management program attribute has not been registered normally, and the user is notified of the error (S110). Then this program ends.

On the other hand, when the storage system 3 reports normal completion, the program attribute registration program 103 sends a message, that registration of the attribute in the storage system 3 has been completed, to the user (S106). Then the program ends.

This storage management program attribute registration processing is started upon an instruction from the user. It may also be automatically executed as a storage management program is installed.

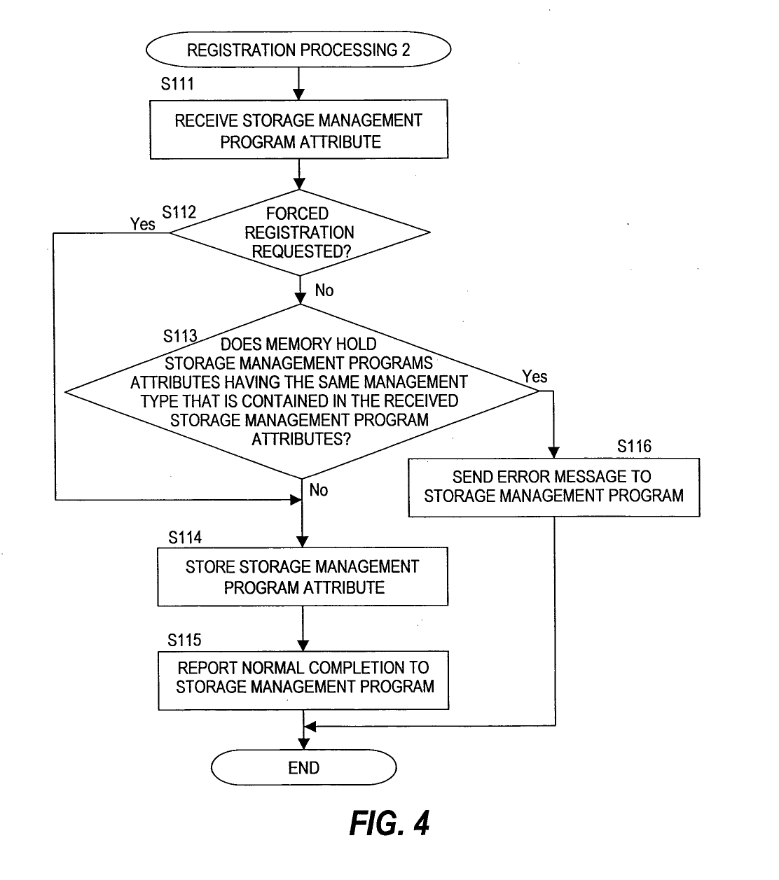

FIG. 4 is a flow chart of Registration Processing Two to register the storage management program attribute 301 according to the first embodiment. This processing is executed by the attribute management program 302 in the controller 31 of the storage system 3.

The controller 31 receives the storage management program attributes from a management server (S111).

The received storage management program attribute is analyzed to judge whether or not they contain a forced registration request (S112).

When it is judged as a result that a forced registration request is contained in the received storage management program attributes, the processing advances to step S114 without checking storage management program attribute that is stored in the memory 32.

On the other hand, when a forced registration request is not contained in the received storage management program attribute, the attribute management program 302 judges whether or not a storage management program of the same management type as the one contained in the received attribute are found in the memory 32 (S1113). Specifically, it is judged whether or not the memory 32 holds storage management program attribute that has the same resource to be managed and management types as those of the received storage management program attribute, and when the received storage management program attribute and the stored storage management program attribute are equal in terms of both management type and resource to be managed, it is judged that a storage management program of the same management type has already been registered.

When a storage management program of the same management type as the one contained in the received attribute is not found in the memory 32, the processing advances to the step S114, where registration processing is started.

In the step S114, the received storage management program attribute is stored in the memory 32. Thereafter, a message reporting normal completion of the processing is sent to the storage management program (management server) that has requested the registration (S115).

When it is judged in the step S113 that the memory 32 holds a storage management program of the same management type as the one contained in the received attribute, an error message is sent to the storage management program (management server) that has requested the registration (S116).

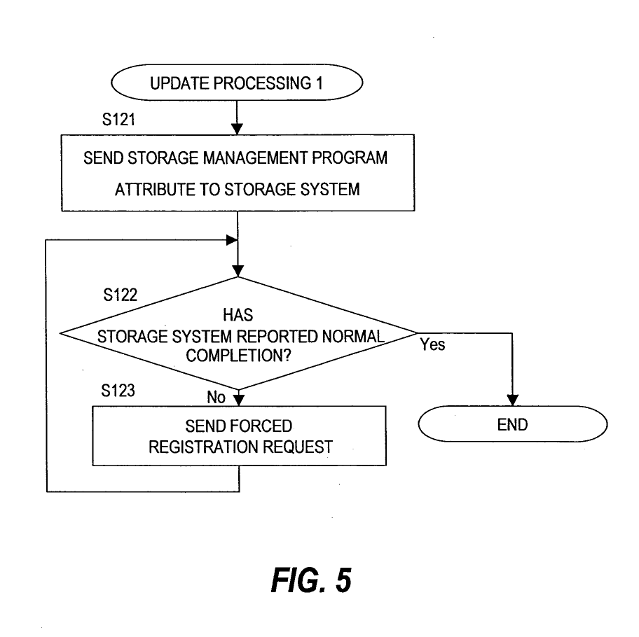

FIG. 5 is a flow chart of Updating Processing One to update the storage management program attribute 301 according to the first embodiment. This processing is executed by the program attribute management program 103.

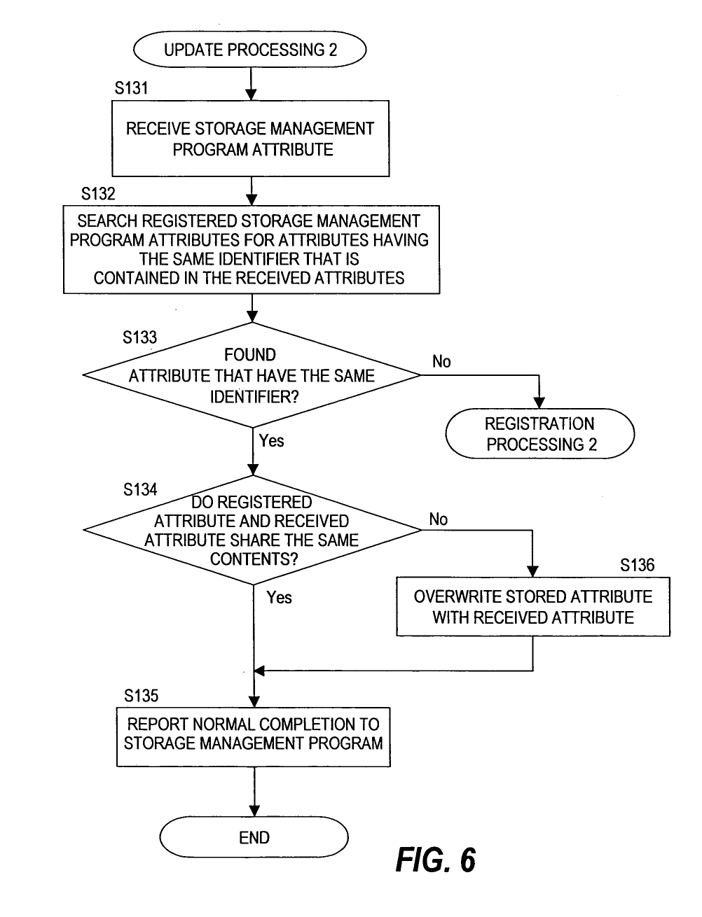

First, storage management program attribute is sent to the storage system 3 (S121). Receiving the storage management program attribute, the storage system 3 starts Update Processing Two shown in FIG. 6.

After sending the storage management program attribute, the program attribute registration program 103 waits for the storage system 3 to report normal completion (S122). When a message saying that the processing has been completed normally is sent from the storage system 3, this processing is ended.

When the storage system 3 reports an error, on the other hand, a forced registration request is sent to the storage system 3 (S123). The processing then returns to the step S122, where the program attribute registration program 103 waits for the storage system 3 to report normal completion.

This storage management program attribute update processing is started upon an instruction from the user, or may be started at a given timing (for example, each time a refresh cycle is started). Alternatively, the update processing may be activated each time the storage management program communicates with the storage system 3.

FIG. 6 is a flow chart of Updating Processing Two to update the storage management program attribute 301 according to the first embodiment. This processing is executed by the program attribute management program 302 in the controller 31 of the storage system 3.

The controller 31 receives storage management program attribute from the management server (S131).

The program attribute management program 302 then searches the storage management program attribute 301 stored in the memory 32 for the identifier contained in the received storage management program attribute (S132), and judges whether or not the memory 32 holds storage management program attribute having an identifier that matches the identifier contained in the received attribute (S133).

When the memory 32 does not hold storage management program attribute having an identifier that matches the identifier contained in the received attribute, the program attribute management program 302 judges that the received storage management program attribute is to be newly registered, and starts the attribute registration processing shown in FIG. 4.

On the other hand, when the memory 32 holds storage management program attribute having an identifier that matches the identifier contained in the received attribute, the received storage management program attribute is compared against the storage management program attribute 301 stored in the memory 32. When it is found as a result of the comparison that the received attribute differ from the stored attribute, the stored attribute is overwritten with the received attribute (S136), and the processing proceeds to S135. When it is found as a result of the comparison that the received attribute is equal to the stored attribute, the processing proceeds to the step S135 without writing the received attribute in the memory 32.

In the step S135, the storage management program (management server) that has requested the update is informed of normal completion of the update processing.

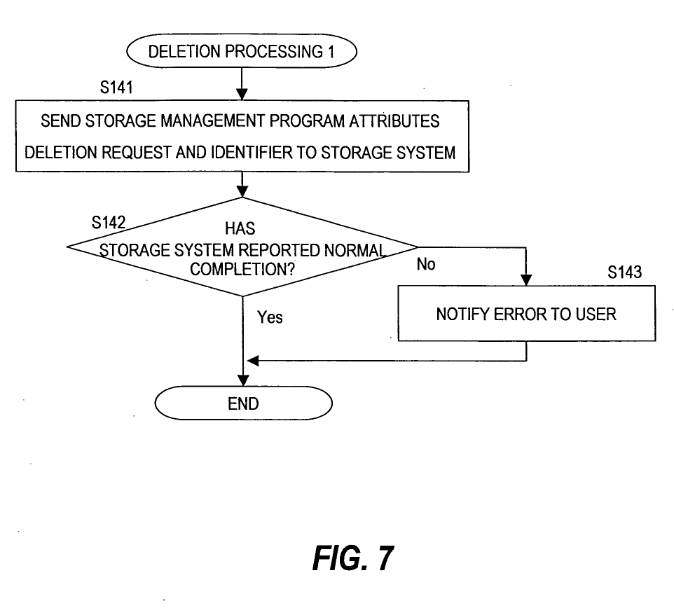

FIG. 7 is a flow chart of Deletion Processing One to delete the storage management program attribute 301 according to the first embodiment. This processing is executed by the attribute management program 103.

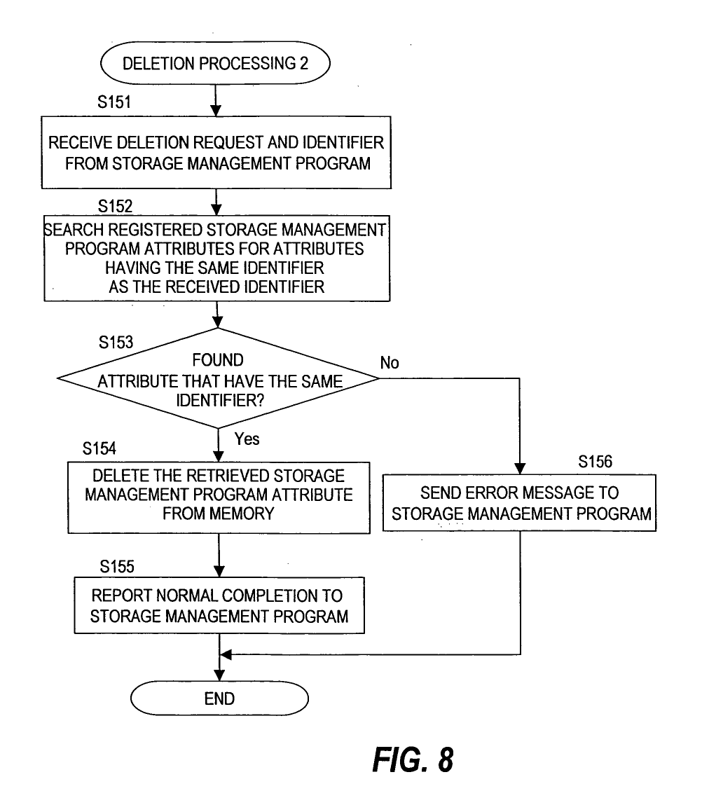

First, a storage management program deletion request and the identifier of the program requested to be deleted are sent to the storage system 3 (S141). Receiving the storage management program deletion request, the storage system 3 starts Deletion Processing Two shown in FIG. 8.

After sending the deletion request, the program attribute registration program 103 waits for the storage system 3 to report normal completion of the processing (S142).

When the program attribute registration program 103 receives an error message from the storage system 3, the user is notified of the error (S143) and this deletion processing is terminated.

When normal completion of the processing is reported by the storage system 3, the program attribute registration program 103 ends this deletion processing.

This storage management program attribute deletion processing is started upon an instruction from the user. It may also be automatically executed as a storage management program is uninstalled.

FIG. 8 is a flow chart of Deletion Processing Two to delete the storage management program attribute 301 according to the first embodiment. This processing is executed by the attribute management program 302 in the controller 31 of the storage system 3.

First, the program attribute management program 302 receives a storage management program attribute deletion request and the identifier of the storage management program whose identifier is requested to be deleted (S151).

The program attribute management program 302 then searches the storage management program attribute 301 stored in the memory 32 for the received identifier (S152) contained in the received storage management program attribute, and judges whether or not the memory 32 holds storage management program attribute having an identifier that matches the identifier contained in the received attribute (S153).

When the memory 32 holds storage management program attribute having an identifier that matches the identifier contained in the received attribute, the storage management program attribute is deleted from the memory 32. Then the storage management program (management server) that has requested the deletion is informed of normal completion of the deletion processing (S155), and the processing is ended.

When the memory 32 does not hold storage management program attribute having an identifier that matches the identifier contained in the received attribute, it means that storage management program attribute that is requested to be deleted are not stored in the memory 32. Accordingly, the program attribute management program 302 sends an error message to the storage management program (management server) that has requested the deletion (S156), and terminates this processing.

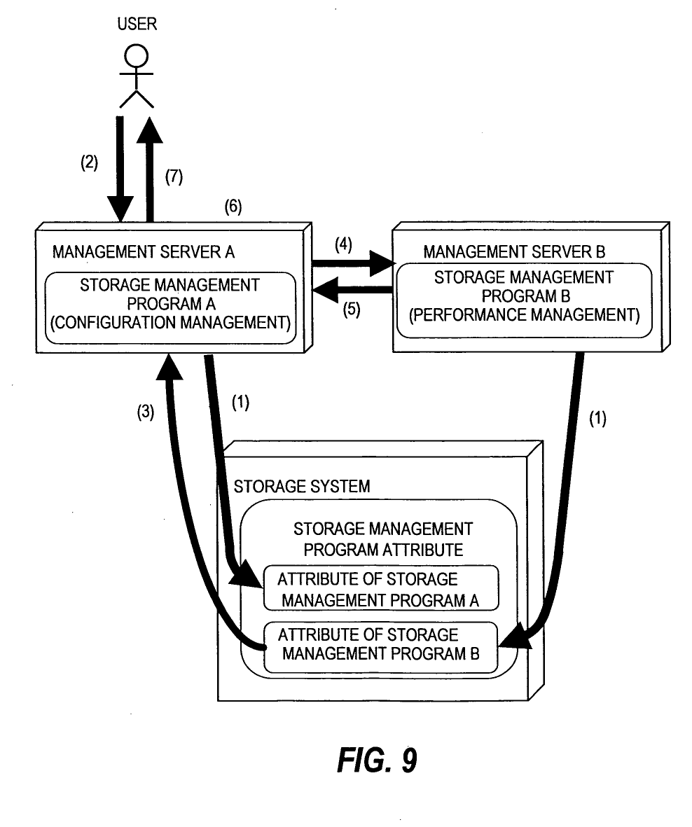

FIG. 9 is an explanatory diagram of how storage management programs cooperate with one another in the first embodiment.

When storage management programs cooperate with one another, one of the cooperating storage management programs calls up another and utilizes information obtained from this other storage management program. The cooperation between the storage management programs is orchestrated mainly by the cooperation program 102.

Here, consider a configuration in which the storage management program A 101 is executed on the management server A 1 and manages the storage system configuration whereas the storage management program B 201 is executed on the management server B 2 and manages the performance of the storage system 3.

When the storage management program A 101 which manages the storage system configuration is installed in the management server A 1, the attribute of the storage management program A 101 is registered in the storage system 3. Similarly, when the storage management program B 201 which manages the storage system performance is installed in the management server B 2, the attribute of the storage management program B 201 is registered in the storage system 3 ((1) in FIG. 9).

Thereafter, the user operates the storage management program A 101 (2). For instance, the user gives an instruction to create a volume in a disk of low I/O access frequency, and the storage management program A 101 calls up the cooperation program 102. The cooperation program 102 makes an inquiry about attribute of a program that manages the performance of the storage system 3 to the program attribute management program 302 of the storage system 3. Receiving the inquiry, the program attribute management program 302 sends, to the cooperation program 102, the attribute inquired (3). For example, the program attribute management program 302 sends the IP address of the management server B 2 in which the storage management program B 201 is executed to the cooperation program 102.

The cooperation program 102 then makes an inquiry about performance information of the storage system 3 to the storage management program B 201 which is executed in the management server B 2 in order to manage the storage system performance (4). Receiving the inquiry, the storage management program B 201 sends, to the storage management program A 101, the performance information inquired (5). The storage management program A 101 thus obtains information on the I/O access frequency of disks in the storage system 3.

The storage management program A 101 uses the performance information obtained from the storage management program B 201 to choose a disk that has low I/O access frequency, and instructs the storage system 3 to create a volume in the chosen disk (6).

When the creation of the volume in the storage system 3 is finished, the user is notified of the completion of the volume creating processing (7).

Those communications between the management servers and between the storage system and the management servers preferably comply with the CIM interface.

In other words, the storage management program A 101 which manages the storage system configuration fulfills user's demands in cooperation with the storage management program B 201 which manages the storage system performance.

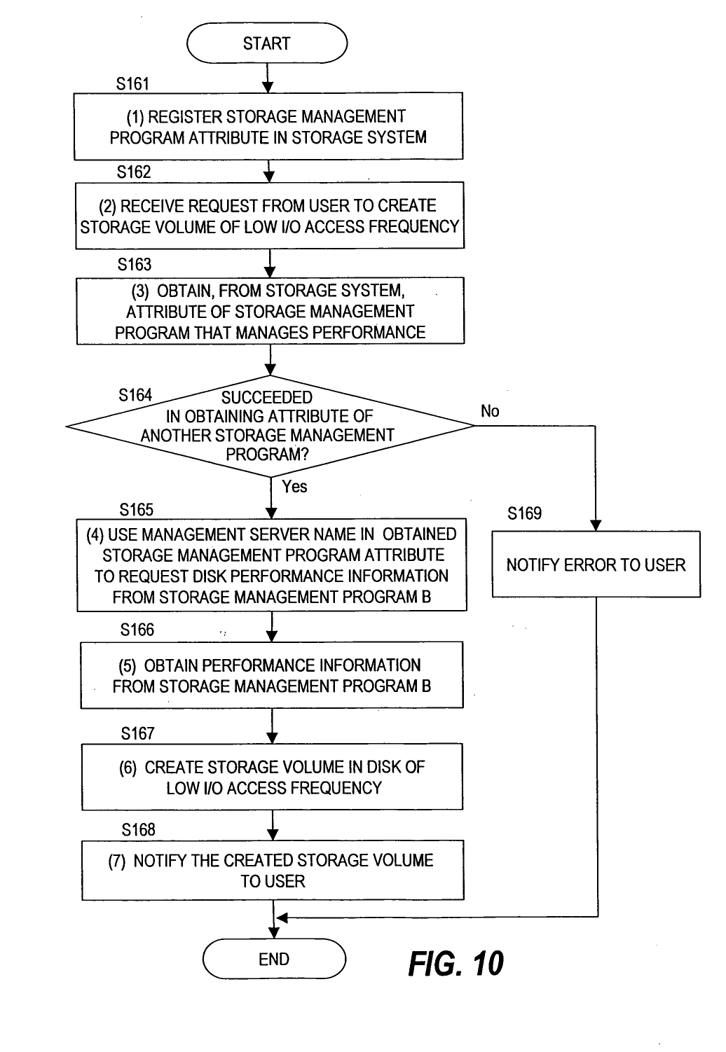

FIG. 10 is a flow chart of cooperation organizing processing performed by the cooperation program 102 in the first embodiment.

First, the program attribute registration program 103 executes Registration Processing One described above with reference to FIG. 3 to register a storage management program attribute in the storage system 3 (S161).

As an instruction to create a volume in a disk of low I/O access frequency is received from the user (S162), the storage management program A 101 judges whether it is necessary to obtain performance information of the storage system 3 or not.

When it is judged that obtaining performance information of the storage system 3 is necessary for execution of the user's request, the cooperation program 102 is requested to provide a storage management program attribute that have “Disk” as a resource to be managed and “performance management” as a management type. Receiving the request, the cooperation program 102 requests the storage system 3 to provide the storage management program attribute. At this point, for security measures, the storage system 3 may authenticate the management server that is trying to obtain the storage management program attribute with the use of given authentication information. For instance, the storage system 3 authenticates by using a preset password or by checking whether or not the attribute of the storage management program (here, the storage management program A 101) of the management server that is asking for the attribute of another storage management program are stored in the storage management program attribute 301 stored in the storage system 3.

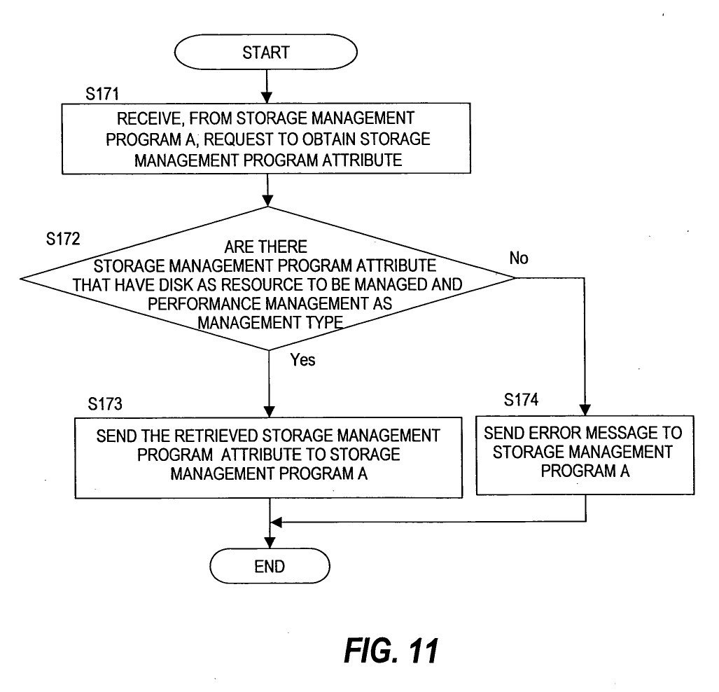

The cooperation program 102 thus obtains, from the storage system 3, the attribute of the storage management program that manages the storage system performance (S163). The request for the attribute starts up processing of the storage system 3 which is shown in FIG. 11.

Then whether necessary the storage management program attribute have been obtained or not is judged (S164).

When it is judged as a result that necessary storage management program attribute have not been obtained, an error message is sent to the storage management program A 101, which has made the request (S169), and this processing is terminated.

On the other hand, when it is judged that necessary the storage management program attribute have been obtained, the processing advances to step S165, where the cooperation program 102 requests the storage management program B 201, which is identified by the obtained attribute, to provide performance information (data about the I/O access frequency of disks) (S165).

Obtaining the data about the I/O access frequency of disks from the storage management program B 201 (S166), the cooperation program 102 identifies a disk having low I/O access frequency to create a volume in the storage system 3 (S167).

As the volume creation is finished, the user is notified that the volume has been created (S168), and the processing is ended.

FIG. 11 is a flow chart of the processing performed in the storage system 3 while the storage management programs are cooperating with one another according to the first embodiment.

First, the storage system 3 receives, from the storage management program A 101, a request for the attribute of the storage management program that manages the storage system performance (S171). Then it is judged whether or not the storage system 3 holds the requested storage management program attribute, namely, a storage management program attribute that have “Disk” as a resource to be managed and “performance management” as a management type (S172). Specifically, it is judged whether the requested the attribute of the storage management program that manages the performance related to disks of the storage system 3 are stored in the memory 32 or not.

When it is judged as a result that the memory 32 holds the storage management program attribute having both the management type and the resource to be managed that are contained in the received request, the storage system 3 sends the storage management program attribute to the storage management program A 101 which has made the request (S173), and ends the processing.

On the other hand, when it is judged that the memory 32 does not hold the storage management program attribute having both the management type and the resource to be managed that are contained in the received request, the storage system 3 sends a message saying that the requested attribute is not stored in the memory 32 to the storage management program A 101 which has made the request (S174), and terminates this processing.

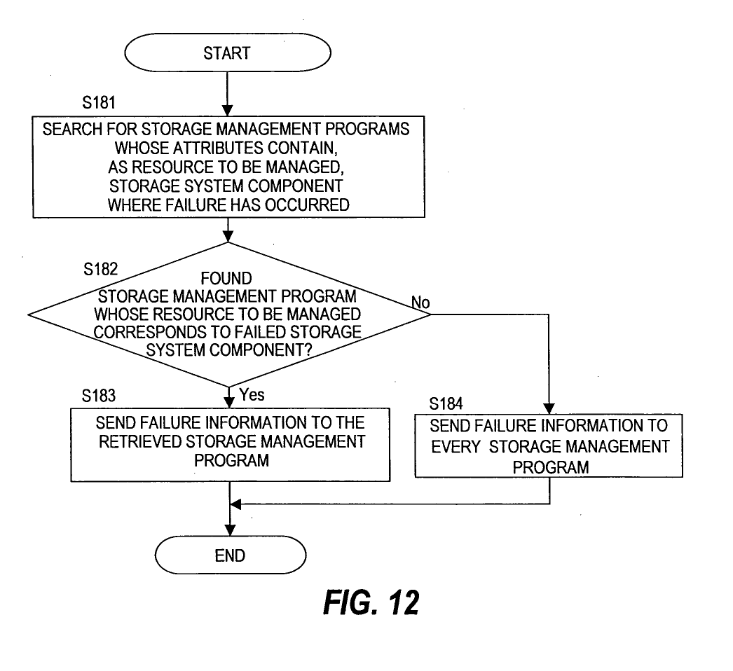

FIG. 12 is a flow chart for processing of notifying a storage management program of a failure according to the first embodiment.

Upon detection of a failure in the storage system 3, the storage management program A 101 searches the storage management program attribute 301 for attribute that have, as a resource to be managed, the failed component of the storage system 3 (S181).

In the case where the search finds attribute that have as a resource to be managed the storage system component that has failed, there is no need to send failure information to other storage management programs than the storage management program identified by the retrieved attribute. Therefore, failure information of the storage system 3 is sent to only the storage management program identified by the retrieved attribute (S182). In the case where the search does not find attribute that have as a resource to be managed the storage system component that has failed, failure information of the storage system 3 is sent to every storage management program (S183).

Thus a storage management program does not receive information about a failure in a component of the storage system 3 that is managed by another storage management program, and the load of the storage management programs is reduced.

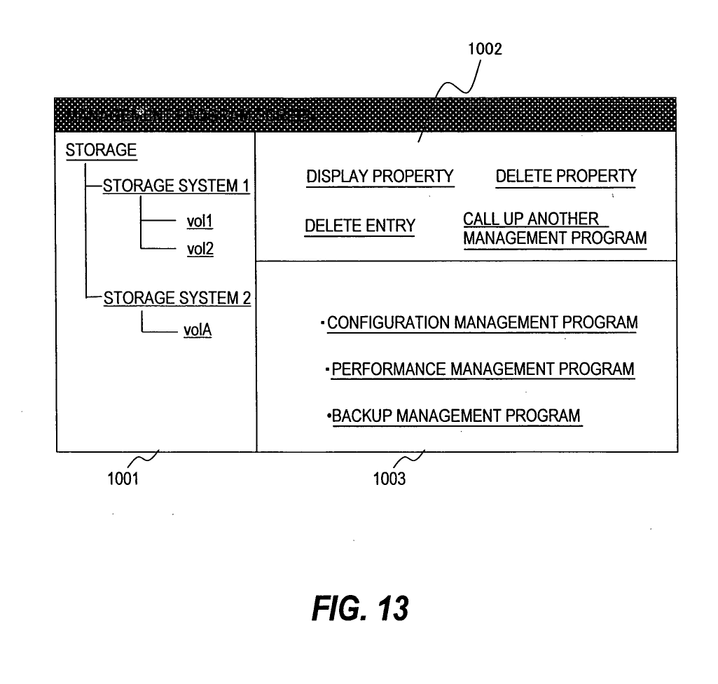

FIG. 13 is an explanatory diagram of a storage management program call-up screen according to the first embodiment.

This management screen is displayed by the cooperation program 102, which is executed in the management server A 1. A similar screen is displayed by the cooperation program 202, which is executed in the management server B 2,

The management screen has a storage system displaying area 1001, an operation selecting area 1002 to select an operation performed on a storage system, and a storage management program selecting area 1003.

Displayed in the storage system displaying area 1001 are the name of a storage system managed by this management server and the name of a volume set in each storage system. Displayed in the operation selecting area 1002 are operations that can be performed on a storage system. Displayed in the management program selecting area 1003 is the name of a storage management program that is available.

The user selects a storage system, or a combination of a storage system and a volume displayed in the storage system displaying area 1001. Then operations that can be performed on the selected storage system are displayed in the operation selecting area 1002.

The user chooses a “call up another management program” operation displayed in the operation selecting area 1002, causing the management program selecting area 1003 to display names of storage management programs that can be used in the chosen operation. Each program on the list of the storage management programs displayed in the management program selecting area 1003 is associated with its link information. The user selects one from the programs displayed in the management program selecting area 1003, and the chosen storage management program is executed.

Names of available storage management programs may be displayed in another window instead of the management program selecting area 1003.

As has been described, in the first embodiment of this invention, registration of a storage system as a resource to be managed in a storage management program is accompanied by registration of the attribute of the storage management program, such as where this program is executed or stored, in the storage system. This makes it possible to obtain, from the storage system, the attribute of the storage management program that manages the storage system. Accordingly, a list of other storage management programs that are available for a call-up from one storage management program can be created without bothering a user.

In contrast to prior art where a user has to create a list of other storage management programs that are available for a call-up from one storage management program, this embodiment is capable of creating a storage management program call-up screen with the use of the storage management program attribute obtained from the storage system 3.

Prior art also requires a user to register, in each storage management program that initiates cooperation, an attribute of its cooperation partner storage management program.

In the first embodiment of this invention, on the other hand, an attribute of a storage management program are registered in a storage system that is a management resource of the storage management program, and another storage management program that plans to cooperate with the former storage management program can obtain the attribute of the former storage management program from the storage system without needing any particular operation on user's part. Thus a storage system can be managed with ease through cooperation between storage management programs.

In other words, this embodiment of this invention enables a storage management program to obtain an attribute of another storage management program that manages this storage system from a storage system which is a management resource of the storage management program. Since the attribute of a storage management program can be obtained from a storage system that is managed by the storage management program, it is easy to find other storage management programs that manage this same storage system without any input from the user.

To summarize, this embodiment of this invention does not allow registration of a storage system in a storage management program as a management resource without registering the attribute of the storage management program in the storage system, and thus makes it possible to obtain from the storage system attribute of any storage management program that manages the storage system. A storage management program can therefore know which of other storage management programs is available for a call-up without relying on a user.

This embodiment of this invention also enables a storage management program to obtain the attribute of other storage management programs as long as they manage the same storage system.

In addition, registering the attribute of a storage management program in a storage system at the same time the storage system is registered in the storage management program as a management resource makes it possible to register the storage management program attribute through a usual set-up operation.

It also eliminates the need to register in advance attribute of its cooperation partner storage management program in a storage management program that initiates cooperation.

With a storage system storing an attribute of storage management programs by which it is managed, the storage system can find storage management programs of the same type from among the storage management programs by which it is managed, and can alert a user of the fact by itself.

A storage management program may not request an attribute of its cooperation partner from a storage system each time the storage management program initiates cooperation. Instead, once a storage management program that initiates cooperation obtains an attribute of its cooperation partner storage management program from a storage system, the cooperation initiating storage management program communicates with the cooperation partner storage management program based on the obtained an attribute, and may not ask the storage system for the attribute again until communications with the cooperation partner storage management program fail due to relocation of the cooperation partner storage management program.

Storing an attribute of storage management programs by which it is managed, a storage system can appropriately judge about where to send failure information. Thus a storage system where a failure has occurred can avoid notifying a storage management program that does not relate to the storage system of the failure.

A storage management program can obtain an attribute of other storage management programs that manage the same storage system irrespective of whether interfaces used between the storage system and the storage management programs vary from one program to another, or not.

Storing a storage management program attribute in a storage system instead of management servers also eliminates the need to update a storage management program attribute in each management server.

Another advantage of this embodiment is that, since a attribute of a storage management program are not available to irrelevant resources, this embodiment can prevent an unexpected operation of a storage system that results from calling up a wrong storage management program.

The cooperation program 102 and the program attribute registration program 103 may be modules of the storage management program A 101.

### Second Embodiment

Described next is another form of cooperation between storage management programs.

In the first embodiment described above, the management server A 1 and the management server B 2 directly communicate with each other. In a second embodiment described below, the management server A 1 and the management server B 2 do not directly communicate with each other.

In the second embodiment, only configurations that differ from those in the first embodiment will be described while configurations that are identical in function and effect in the first and second embodiments are denoted by the same reference symbols and explanations thereof are omitted.

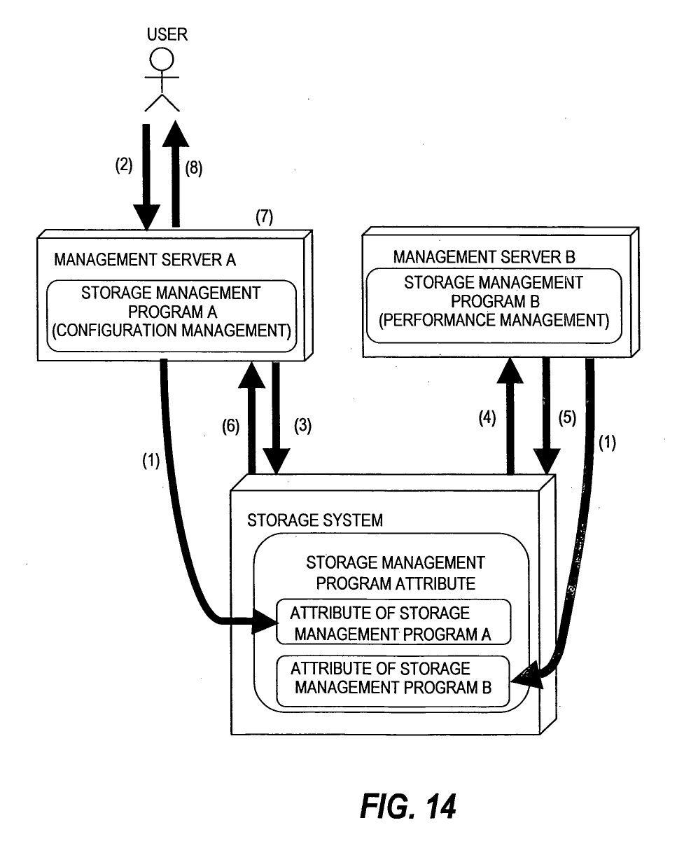

FIG. 14 is an explanatory diagram of how storage management programs cooperate with one another in the second embodiment.

In the second embodiment, a cooperation program is stored in the memory 32 of the storage system 3. In this cooperation program, the storage system 3 calls up the storage management program A 101 and the storage management program B 201 to perform processing of sending and receiving data.

First, as the storage management program A 101 which manages the storage system configuration is installed in the management server A 1, the attribute of the storage management program A 101 are registered in the storage system 3 by the program attribute management program 302. As the storage management program B 201 which manages the storage system performance is installed in the management server B 2, the attribute of the storage management program B 201 are registered in the storage system 3 (1).

Thereafter, a user operates the storage management program A 101 (2). For instance, when the user gives an instruction to create a volume in a disk of low I/O access frequency, the storage management program A 101 requests the storage system 3 to provide performance information (data about the I/O access frequency of disks) of the storage system 3 (3).

Receiving the request for performance information, the program attribute management program 302 identifies a program that manages the performance of the storage system 3. Then, the program attribute management program 302 of the storage system 3 sends the attribute of the identified program to the cooperation program stored in the memory 32. For example, the program attribute management program 302 sends the IP address of the management server B 2 in which the storage management program B 201 is executed to the cooperation program. The cooperation program then requests performance information of the storage system 3 from the storage management program B 201 which is executed in the management server B 2 in order to manage the storage system performance (4).

Receiving the request, the storage management program B 201 sends the requested performance information to the cooperation program of the storage system 3 (5).

The cooperation program of the storage system 3 sends the received performance information to the storage management program A 101 (6). The storage management program A 101 thus obtains information about the I/O access frequency of disks in the storage system 3.

The storage management program A 101 uses the performance information obtained from the storage management program B 201 to choose a disk that has low I/O access frequency, and instructs the storage system 3 to create a volume in the chosen disk (7).

When the creation of the volume in the storage system 3 is finished, the user is notified of the completion of the volume creating processing (8).

In short, the storage management program A 101, which manages the storage system configuration, fulfills user's demands in cooperation with the storage management program B 201, which manages the storage system performance, via the storage system 3.

As in the first embodiment described above, when a storage management program obtains an attribute of another storage management program from a storage system, the validity of a device that provides the attribute may be checked as security measures.

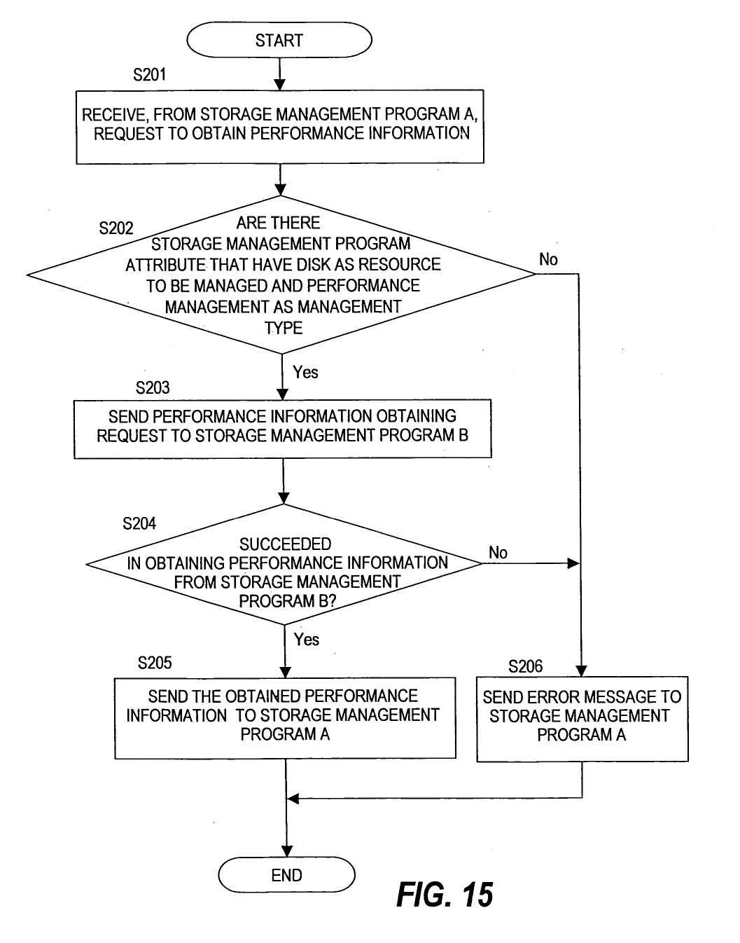

FIG. 15 is a flow chart of processing performed by the program attribute registration program 302 and cooperation program of the storage system 3 in the second embodiment. Steps S201 and S202 in FIG. 15 are processing performed by the program attribute registration program 302 whereas the rest is processing performed by the cooperation program.

First, the storage system 3 receives, from the storage management program A 101, a request for performance information provided by a storage management program that manages the storage system performance (S201). Then, the request contains the management type and a management resource of the storage management program. Referring to the management type and the management resource which are contained in the received request, the storage system 3 judges whether or not it holds the attribute of the storage management program from which the requested performance information is to be obtained (S202). Specifically, it is judged whether the attribute of the storage management program that manages the performance of the storage system 3 are stored in the memory 32 or not.

When it is judged as a result that the memory 32 does not holds storage management program attribute having both the management type and the management resource that are contained in the request, the storage management program from which the requested performance information is to be obtained cannot be identified. Accordingly, the requested performance information cannot be obtained. Then an error message saying that the requested performance information cannot be obtained is sent to the storage management program A 101 which has made the request (S206), and this processing is terminated.

When it is judged that the memory 32 holds an attribute having both the management type and the management resource that are contained in the request, the processing proceeds to step S203, where a request for performance information (data about the I/O access frequency of disks) is sent to the storage management program B 201 which is identified by the attribute.

The cooperation program waits, for a given period of time, for the storage management program B 201 to confirm reception of the request, and judges whether the reception confirmation has been received from the storage management program B 201 or not (S204).

When it is judged that the requested performance information has been obtained, the requested performance information is sent to the storage management program A 101, which has issued the request (S205), and this processing is ended.

On the other hand, when it is judged as a result that the requested performance information has not been obtained, the storage management program A 101, which has issued the request, is notified of the failure in obtaining the requested performance information (S206), and this processing is terminated.

As has been described, according to the second embodiment, a storage management program can obtain an attribute of another storage management program without direct communications between the management server A 1 and the management server B 2.

### Third Embodiment

A still another form of cooperation between storage management programs will be described next.

In the first embodiment described above, the management server A 1 uses the storage management program attribute obtained from the storage system 3 to ask the management server B 2 for performance information. In a third embodiment described below, the storage system 3 asks the management server B 2 for performance information in place of the management server A 1.

In the third embodiment, only configurations that differ from those in the first embodiment will be described while configurations that are identical in function and effect in the first and third embodiments are denoted by the same reference symbols and explanations thereof are omitted.

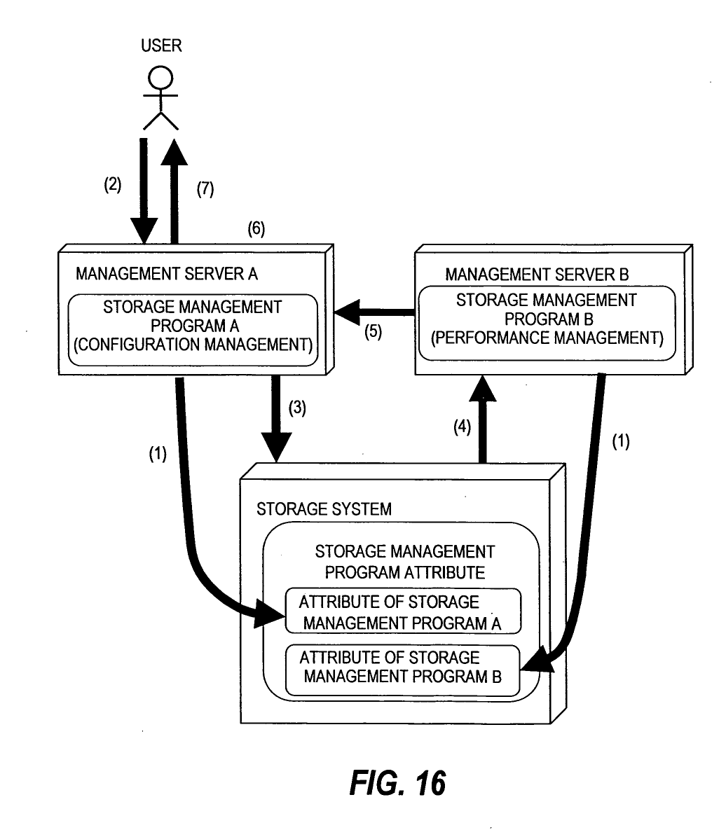

FIG. 16 is an explanatory diagram of how storage management programs cooperate with one another in the third embodiment.

In the third embodiment, a cooperation program is stored in the memory 32 of the storage system 3. In this cooperation program, the storage system 3 calls up the storage management program A 101 and the storage management program B 201 to perform processing of sending and receiving data.

First, as the storage management program A 101 which manages the storage system configuration is installed in the management server A 1, the attribute of the storage management program A 101 are registered in the storage system 3. As the storage management program B 201 which manages the storage system performance is installed in the management server B 2, the attribute of the storage management program B 201 are registered in the storage system 3 (1).

Thereafter, a user operates the storage management program A 101 (2). For instance, the user gives an instruction to create a volume in a disk of low I/O access frequency, and the storage management program A 101 requests the storage system 3 to provide performance information (data about the I/O access frequency of disks) of the storage system 3 (3).

Receiving the request for performance information, the storage system 3 identifies a program that manages the performance of the storage system 3. The storage system 3 sends the attribute of the identified program to the cooperation program stored in the memory 32. For example, the storage system 3 sends the IP address of the management server B 2 in which the storage management program B 201 is executed to the cooperation program. The cooperation program then requests performance information of the storage system 3 from the storage management program B 201 which is executed in the management server B 2 in order to manage the storage system performance (4). The request sent to the storage management program B 201 also contains the attribute of the storage management program that has requested the performance information (the storage management program A 101).

Receiving the request, the storage management program B 201 uses the performance information request from the storage system 3 to identify the storage management program that has requested the performance information (the storage management program A 101). Then the storage management program B 201 sends the requested performance information to the storage management program A 101 (5).

The storage management program A 101 uses the performance information obtained from the storage management program B 201 to choose a disk that has low I/O access frequency, and instructs the storage system 3 to create a volume in the chosen disk (6).

When the creation of the volume in the storage system 3 is finished, the user is notified of the completion of the volume creating processing (7).

In short, the storage management program A 101, which manages the storage system configuration, fulfills user's demands in cooperation with the storage management program B 201, which manages the storage system performance, via the storage system 3.

As in the first embodiment described above, when a storage management program obtains from a storage system an attribute of another storage management program, the validity of a device that provides the attribute may be checked as security measures.

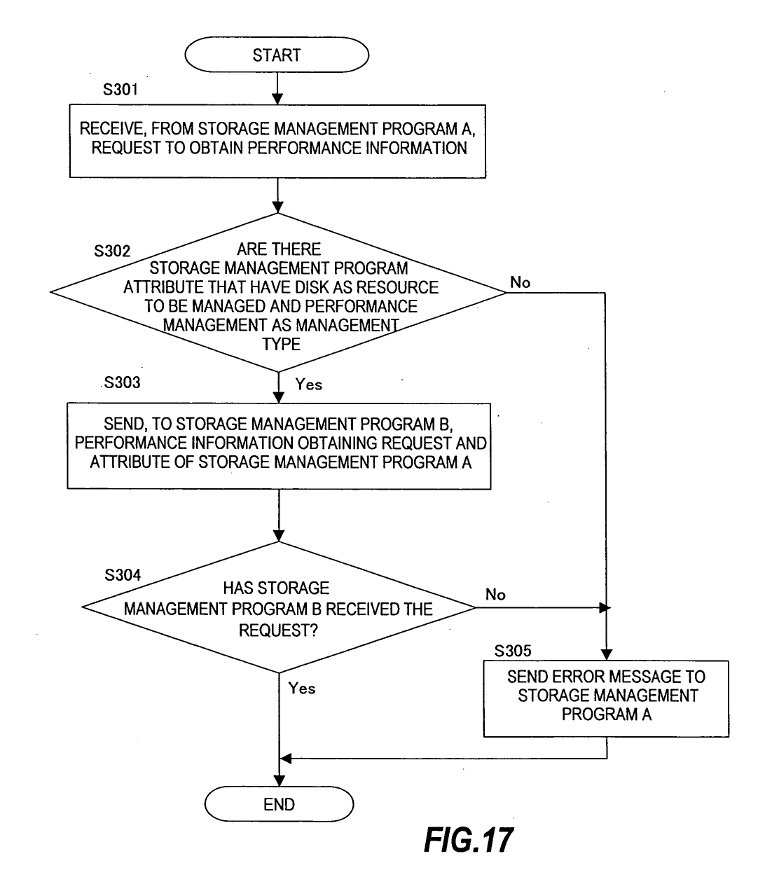

FIG. 17 is a flow chart of processing performed by the attribute management program 302 and cooperation program of the storage system 3 in the third embodiment. Steps S301 and S302 in FIG. 17 are processing performed by the attribute management program 302 whereas the rest is processing performed by the cooperation program.

First, the storage system 3 receives, from the storage management program A 101, a request for performance information provided by a storage management program that manages the storage system performance (S301). The request contains the management type and a management resource of the storage management program. Referring to the management type and the management resource which are contained in the received request, the storage system 3 judges whether or not it holds the attribute of the storage management program from which the requested performance information is to be obtained (S302). Specifically, it is judged whether the attribute of the storage management program that manages the performance of the storage system 3 are stored in the memory 32 or not.

When it is judged as a result that the memory 32 does not holds the storage management program attribute having both the management type and the management resource that are contained in the request, the storage management program from which the requested performance information is to be obtained cannot be identified. Accordingly, the requested performance information cannot be obtained. Then an error message saying that the requested performance information cannot be obtained is sent to the storage management program A 101 which has made the request (S305), and this processing is terminated.

When it is judged that the memory 32 holds the attribute having both the management type and the management resource that are contained in the request, the processing proceeds to step S303, where a request for performance information (data about the I/O access frequency of disks) is sent to the storage management program B 201 which is identified by the attribute.

The cooperation program waits, for a given period of time, for the storage management program B 201 to confirm reception of the request, and judges whether the reception confirmation has been received from the storage management program B 201 or not (S304).

When it is judged that the reception confirmation has been received, it means normal transition of processing to the storage management program B 201, and the processing by the cooperation program is ended.

When it is judged that the reception confirmation has not been received, the cooperation program notifies the storage management program A 101 which has made the request of the failure in obtaining the requested performance information (S305), and terminates this processing.

As has been described, the third embodiment is capable of lessening the burden of a storage management program in obtaining attribute of another storage management program.

While the present invention has been described in detail and pictorially in the accompanying drawings, the present invention is not limited to such detail but covers various obvious modifications and equivalent arrangements, which fall within the purview of the appended claims.

What is claimed is:

1. A computer system comprising a first management server, a second management server, and a storage system,
wherein the first management server comprises a control unit to execute a first storage management program which manages the storage system,
wherein the second management server comprises a control unit to execute a second storage management program which manages the storage system in a manner different from the first storage management program,
wherein the storage system comprises a storing unit to store an attribute of the first storage management program which manages the storage system and an attribute of the second storage management program which manages the storage system, and
wherein the first storage management program obtains the attribute of the second storage management program from the storage system to manage the storage system.

2. The computer system according to claim 1,
wherein, upon receiving a request to store the attribute of a storage management program that manages the storage system, the storage system judges whether it stores the attribute of the storage management program whose management type and resource to be managed similar to those of the storage management program whose attribute is requested to be stored, and
wherein, when the storage system stores an attribute of the storage management program whose management type and resource to be managed are identical to those of the storage management program whose attribute is requested to be stored, the storage system sends an error message to the server that has made the request.

3. The computer system according to claim 1,
wherein the storage system stores the attribute of the storage management program, and
wherein the attribute of the storage management program includes a name of the storage management program that manages the storage system, a name of the management server in which the storage management program is executed, a management type of the storage management program, an identifier of the storage management program, and a resource to be managed by the storage management program.

4. The computer system according to claim 1, wherein, when a failure occurs in the storage system, the storage system refers to the attribute of the storage management program attribute, identifies a storage management program relating to a part in which the failure occurs, and determines that the identified storage management program is a destination of a failure notification.

5. The computer system according to claim 1,
wherein the first management server judges whether to register the storage system in the first storage management program and, when it is judged that the registration is necessary, sends attribute of the first storage management program to the storage system,
wherein, upon receiving the attribute of the first storage management program that manages the storage system, the storage system judges whether it stores the attribute of the storage management program whose management type and resource to be managed similar to those of the first storage management program and, when none of the attribute of the storage management program stored in the storage system have neither the same management type nor the same resource to be managed identical to those of the first storage management program, the storage system stores the received attribute of the first storage management program, and then the storage system sends a message that indicates a completion of storing the attribute to the first management server, and
wherein, upon receiving of the message that indicates the completion of storing the attribute, the first management server obtains information of the resource managed by the first storage management program.

6. The computer system according to claim 1,
wherein, upon receiving a request to update the attribute of the storage management program which manages the storage system, the storage system judges whether it stores the attribute of the storage management program whose identifier is same as that of the storage management program whose attribute is requested to be updated,
wherein, when the storage system dose not store the attribute of the storage management program whose identifier is same as that of the storage management program whose attribute is requested to be updated, the storage system stores the attribute of the storage management program contained relating the received request, and
wherein, when the storage system stores the attribute of the storage management program whose identifier is same as that of the storage management program whose attribute is requested to be updated, the storage system executes predetermined attribute update processing and sends a message that indicates a completion of updating the attribute to the first management server.

7. The computer system according to claim 1,
wherein, after sending the attribute of the first storage management program to the storage system, in the case where the first management server does not receive, from the storage system, a message informing that attribute of the first storage management program that have been sent to the storage system are now stored in the storage system, the first management server requests the storage system to accept forced registration of attribute of the first storage management program, and
wherein, upon receiving the forced registration request from the first management server, the storage system stores the previously received the attribute of the first storage management program irrespective of whether it holds the attribute of the storage management program that has the same management type and resource to be managed as those of the first storage management program.

8. The computer system according to claim 1, wherein, upon receiving a request to delete the attribute of the storage management program which manages the storage system, the storage system deletes the attribute of the storage management program whose identifier is same as that of the storage management program whose attribute is requested to be deleted.

9. A program call-up method for a computer system composed of a first management server, a second management server, and a storage system,
the first management server comprising a control unit to execute a first storage management program which manages the storage system,
the second management server comprising a control unit to execute a second storage management program which manages the storage system in a manner different from the first storage management program,
the storage system comprising a storing unit to store an attribute of the first storage management program which manages the storage system and an attribute of the second storage management program which manages the storage system, the method comprising the steps of:
the first storage management program obtaining the attribute of the second storage management program from the storage system to manage the storage system, and
the storage management program calling up the second storage management program with the use of the obtained attribute of the second storage management program.

10. A storage system comprising:
disks to store data,
a control unit to control input/output data to/from the disks and
a storing unit to store the attribute of the storage management programs that manage the storage system,
wherein the control unit receives, from one of the storage management programs, a request for the attribute of another of the storage management programs, and sends the attribute of the storage management program stored in the storing unit to the storage management program that has made the request.

11. The storage system according to claim 10, wherein, upon detection of a failure in the storage system, the control unit searches for the storage management programs relating to a location of the failure, and sends the detected failure to the storage management program.
